(19) United States
(12) Patent Application Publication
(10) Pub. No.: US 2012/0097036 A1
(43) Pub. Date: Apr. 26, 2012

(54) FILTER AND HOME APPLIANCE COMPRISING THE SAME

(76) Inventors: Okchun HYUN, Seoul (KR); Hyungho Park, Seoul (KR); Sunghwa Lee, Seoul (KR)

(21) Appl. No.: 13/273,481

(22) Filed: Oct. 14, 2011

(30) Foreign Application Priority Data
Oct. 22, 2010 (KR) 10-2010-0103456

(51) Int. Cl. B03C 3/00

(52) U.S. Cl. 96/55

(57) ABSTRACT

Provided are a filter and a home appliance including the filter. In one embodiment, a filter comprises: a first main filter member and a second main filter member, which are at least partially spaced apart from each other, and generate static electricity with each other; and at least one auxiliary filter member attached to at least one of the first and second main filter members, and coated with a material for providing at least one of a sterilization function, an anti-bacterial function, a deodorization function, and an anti-allergic function.

### CROSS-REFERENCE TO RELATED APPLICATIONS

The present application claims the benefit of priority under 35 U.S.C. 119 to Korean Patent Application No. 10-2010-0103456 (filed on Oct. 22, 2010) which is hereby incorporated by reference in its entirety.

### BACKGROUND

The present disclosure relates to a filter and a home appliance including the filter.

Filters remove various impurities from gas such as air or liquid such as water. Such filters are used in various home appliances such as air conditioners for cooling and/or heating an indoor space, or air cleaners for purifying indoor air.

Filters may be classified into filters using a physical filtering method, filters using a chemical decomposing method, and filters using an electrical collecting method, according to filtering methods. Filters using the physical filtering method trap relatively large impurities. Filters using the chemical decomposing method decompose impurities through oxidation decomposition. Filters using the electrical collecting method collect impurities by means of electrostatic force.

However, such filters have the following limitations. Filters using the electrical collecting method may be further classified into filters that build up static electricity only by applying an electric field, and electrostatic filers that build up static electricity without applying an electric field by manufacturing the filters through a polarization process using corona discharge or high electric field. When an electrostatic filter is coated with a material for providing an additional function such as a sterilization function, an anti-bacterial function, a deodorization function, and an anti-allergic function, its electrostatic performance may be degraded or eliminated. Thus, it may be difficult to manufacture a multi-functional filter.

### SUMMARY

Embodiments provide a multi-functional filter and a home appliance including the filter.

In one embodiment, a filter comprises: a first main filter member and a second main filter member, which are at least partially spaced apart from each other, and generate static electricity with each other; and at least one auxiliary filter member attached to at least one of the first and second main filter members, and coated with a material for providing at least one of a sterilization function, an anti-bacterial function, a deodorization function, and an anti-allergic function.

In another embodiment, a filter comprises: a first main filter member and a second main filter member, which are at least partially spaced apart from each other to form a channel through which air flows, and which generate static electricity with each other, wherein at least one of the first and second main filter members includes: a first member generating static electricity with the other of the first and second main filter members; and at least one second member attached to the first member, and coated with a material for providing at least one of a sterilization function, an anti-bacterial function, a deodorization function, and an anti-allergic function.

In another embodiment, a home appliance comprises: a casing; an intake port introducing air into the casing; a discharge port discharging air out of the casing; a blowing fan providing driving force for causing air flow in and out of the casing through the intake port and the discharge port; and a filter removing an impurity from air flowing in and out of the casing through the intake port and the discharge port, wherein the filter includes: a first main filter member and a second main filter member, which are at least partially spaced apart from each other, and generate static electricity with each other; and at least one auxiliary filter member attached to at least one of the first and second main filter members, and coated with a material for providing at least one of a sterilization function, an anti-bacterial function, a deodorization function, and an anti-allergic function.

The details of one or more embodiments are set forth in the accompanying drawings and the description below. Other features will be apparent from the description and drawings, and from the claims.

### BRIEF DESCRIPTION OF THE DRAWINGS

FIG. 1 is a front view illustrating a filter according to a first embodiment.

FIG. 2 is a cross-sectional view illustrating a principal part of the filter according to the first embodiment.

FIG. 3 is a cross-sectional view illustrating a principal part of a filter according to a second embodiment.

FIG. 4 is a cross-sectional view illustrating a principal part of a filter according to a third embodiment.

FIG. 5 is a schematic view illustrating an air conditioner according to an embodiment.

FIG. 6 is a block diagram illustrating the air conditioner of FIG. 5.

### DETAILED DESCRIPTION OF THE EMBODIMENTS

A filter according to a first embodiment will now be described with reference to the accompanying drawings.

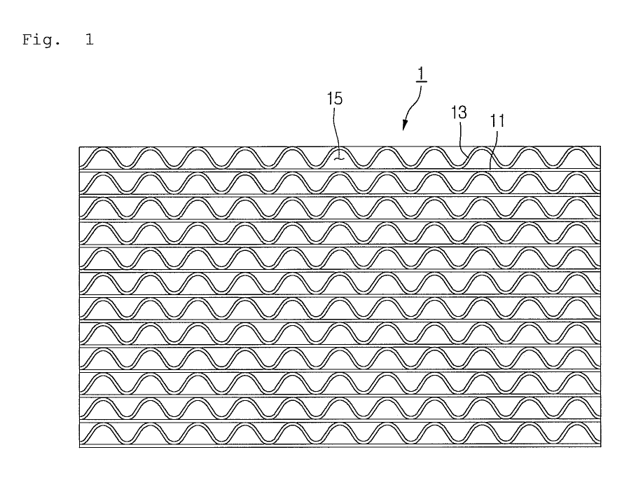

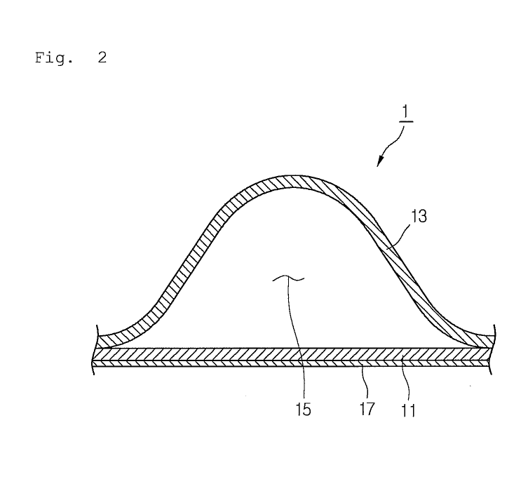

FIG. 1 is a front view illustrating a filter according to the first embodiment. FIG. 2 is a cross-sectional view illustrating a principal part of the filter according to the first embodiment.

Referring to FIGS. 1 and 2, a filter 1 according to the current embodiment includes a plurality of first main filter members 11 and a plurality of second main filter members 13. The first main filter members 11 have a plate shape, and the second main filter members 13 has a wave shape or a snake shape formed by bending a plate at a number of times. A plurality of the first main filter members 11 and a plurality of the second main filter members 13 are alternately stacked in a vertical direction. In other words, the second main filter members 13 are placed on the top surfaces of the first main filter members 11. Thus, a portion of the bottom surface of the second main filter members substantially contacts the top surface of the first main filter members 11.

Substantially, predetermined spaces (hereinafter, referred to as channels 15 for convenience in description) is formed between the top surface (or the bottom surface) of the first main filter members 11 and the bottom surface (or the top surface) of the second main filter members 13. Air, which is filtered by the filter 1, flows through the channels 15.

Referring to FIG. 2, the first and second main filter members 11 and 13 may be formed from a film capable of generating static electricity, such as a film formed of polypropylene as a polymer plastic. That is, static electricity generated from the first and second main filter members 11 and 13 is substantially used to electrically collect impurities from air flowing through the channels 15.

An auxiliary filter member 17 is attached to a surface of the first main filter members 11. The auxiliary filter members 17 have a function different from the function that the first and second main filter members 11 and 13 electrically collect impurities. For example, the auxiliary filter members 17 may have at least one of a sterilization function, an anti-bacterial function, a deodorization function, and anti-allergic function. To this end, the auxiliary filter members 17 may be formed of a predetermined material such as polypropylene used to form the first and second main filter members 11 and 13, but is not limited thereto. The auxiliary filter members 17 are coated with a material for providing an additional function.

Although not shown, the auxiliary filter members 17 may be attached to a surface of the second main filter members 13. The auxiliary filter members 17 may be attached to both a surface of the first main filter members 11 and a surface of the second main filter members 13 to have the above described function.

The second main filter members 13 may be coated with different materials for providing different functions. For example, one of the second main filter members 13 may be coated with a sterilizing material or anti-bacterial material, another one thereof may be coated with a deodorizing material, and another one thereof may be coated with an anti-allergic material. Furthermore, the second main filter member 13 may be coated with two or more different materials for providing different functions.

The filter 1 may be formed by vertically stacking modules, each of which includes the first main filter member 11, the second main filter member 13, and the auxiliary filter member 17. Alternatively, the filter 1 may be formed by vertically stacking modules, each of which includes the first main filter member 11 and the second main filter member 13, and attaching the auxiliary filter member 17 to at least one of the first main filter member 11 and the second main filter member 13.

Hereinafter, an operation of a filter according to the first embodiment will now be described with reference to the accompanying drawings.

When air flows through the channels 15, impurities are collected from the air by means of static electricity generated from the first and second main filter members 11 and 13. At this point, the impurities in the air may be charged in advance by an electrifying device, so that the first and second main filter members 11 and 13 can more efficiently collect the impurities, which will be described later.

While the air flows through the channels 15, the auxiliary filter members 17 may perform a sterilization process, a deodorization process, and an anti-allergic process on the air. In this case, at least one of the processes may be performed according to materials formed on the auxiliary filter members 17.

Hereinafter, a filter according to a second embodiment will now be described with reference to the accompanying drawing.

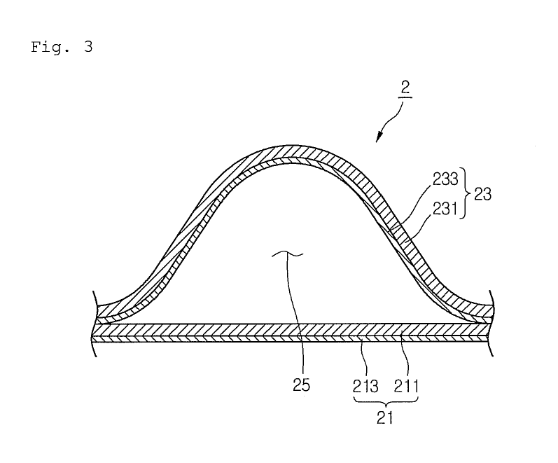

FIG. 3 is a cross-sectional view illustrating a principal part of a filter according to the second embodiment.

Referring to FIG. 3, a first main filter member 21 according to the current embodiment includes a first member 211 and a second member 213. A predetermined material, for example, a nonwoven fabric formed of polypropylene may be used to form the first member 211. The first member 211 is adapted to generate static electricity. The second member 213 is attached to a surface of the first member 211. A material coated with a predetermined material to perform an additional function, for example, a nonwoven fabric formed of polypropylene may be used to form the second member 213.

A second main filter member 23 includes a third member 231 and a fourth member 233. The third member 231 may be the same in configuration as the first member 211. The fourth member 233 is different from the second member 213 in that the fourth member 233 is not coated with a predetermined material to perform an additional function.

Alternatively, the second main filter member 23 may be the same in configuration as the first main filter member 21. In other words, the fourth member 233 may also be coated with a predetermined material to perform an additional function, like the second member 213.

Hereinafter, a filter according to a third embodiment will now be described with reference to the accompanying drawing.

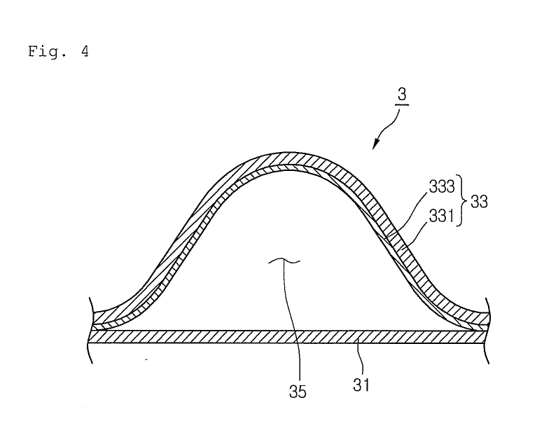

FIG. 4 is a cross-sectional view illustrating a principal part of a filter according to the third embodiment.

Referring to FIG. 4, a first main filter member 31 according to the current embodiment is the same in configuration as the first main filter member 21 of a filter 2 according to the second embodiment, and a second main filter member 33 according to the current embodiment is the same in configuration as the second main filter member 13 of the filter 1 according to the first embodiment. Alternatively, the first main filter member 31 and the second main filter member 33 may be the same in configuration as the first main filter member 11 according to the first embodiment and the second main filter member 23 according to the second embodiment, respectively. This is described in detail in the first and second embodiments.

Hereinafter, a configuration of an air conditioner according to an embodiment will now be described with reference to the accompanying drawings.

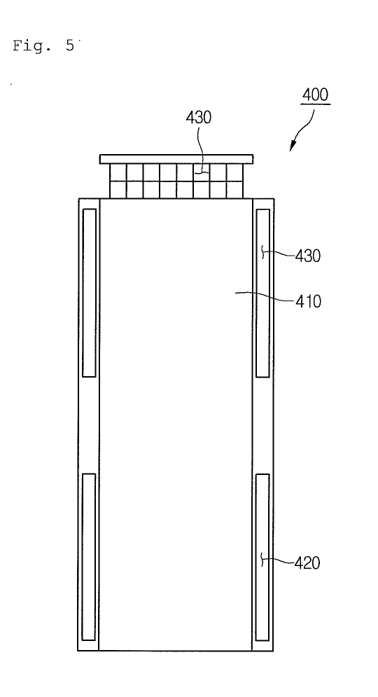

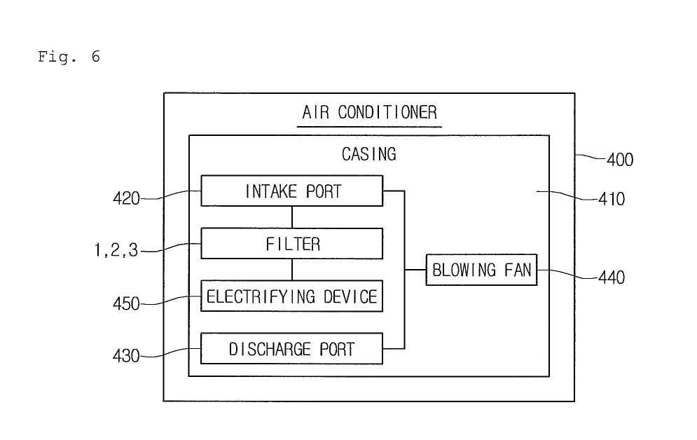

FIG. 5 is a schematic view illustrating an air conditioner according to an embodiment. FIG. 6 is a block diagram illustrating the air conditioner of FIG. 5.

Referring to FIGS. 5 and 6, an air conditioner 400 according to the current embodiment includes a plurality of intake ports 420, a plurality of discharge ports 430, a blowing fan 440, a plurality of filters 1, 2 or 3, and an electrifying device 450. The filters 1, 2, and 3 are filters according to the first, second, and third embodiments, respectively.

In more detail, the intake ports 420 and the discharge ports 430 are provided to a casing 410 constituting the appearance of the air conditioner 400. For example, the intake ports 420 are disposed at both side lower ends of the casing 410, and the discharge ports 430 are disposed at both sides of the casing 410 and an upper surface of the casing 410 (substantially, an pop-up part protruding upward from an upper surface of the casing 410. However, the positions of the intake ports 420 and the discharge ports 430 are not limited thereto. The intake ports 420 introduce air to the casing 410, and the discharge ports 430 discharge air from the casing 410.

The blowing fan 440 is disposed in the casing 410 to generate driving force for causing air flow in and out of the casing 410 through the intake ports 420 and the discharge ports 430. The air flow caused by the blowing fan 440 substantially exchanges heat with a heat exchanger (not shown) disposed in the casing 410, to thereby cool or heat an indoor space.

The filters 1, 2, or 3 are disposed in paths of air flowing in and out of the casing 410 through the intake ports 420 and the discharge ports 430. For example, the filters 1, 2, or 3 may be disposed in the casing 410 near the intake ports 420. In this case, imaginary lines parallel to the channels of the filters 1, 2, or 3 may be perpendicular to imaginary planes on which the intake ports 420 are disposed.

An impurity of air to be filtered by the filters 1, 2, or 3 is positively or negatively charged through corona discharge by the electrifying device 450. Accordingly, the filters 1, 2, or 3 can more efficiently collect impurities. The electrifying device 450 may charge impurities of air introduced into the casing 410 through the intake ports 420, at least before the air passes through the filters 1, 2, or 3, substantially before flowing through the channels thereof.

Hereinafter, an operation of an air conditioner according to an embodiment will now be described.

When the air conditioner 400 is operated, the blowing fan 440 introduces air into the casing 410 through the intake ports 420. The blowing fan 440 is continually driven to move the introduced air to the heat exchanger. The air moved to the heat exchanger exchanges heat with the heat exchanger, and then, is discharged into an indoor space through the discharge ports 430. Accordingly, the indoor space is cooled or heated.

Impurities of the air introduced through the intake ports 420 are positively discharged by the electrifying device 450. While the impurities are charged by the electrifying device 450, the air passes through the filters 1, 2, or 3. At this point, the discharged impurities are collected. The second main filter member 33 or a second member 213 may perform an additional function such as a sterilization function, an anti-bacterial function, a deodorization function, and anti-allergic function. Thus, a more comfortable environment can be created while the indoor space is heated or cooled.

Although filters are applied to an air conditioner according to the above described embodiments, the filters may be applied to another home appliance such as an air cleaner.

According to the embodiments, a filter and a home appliance including the filter include various materials to provide additional functions to the filter for electrically collecting impurities. Thus, the filter not only collects impurities, but also performs various additional operations.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A filter comprising:
a first main filter member and a second main filter member, which are at least partially spaced apart from each other, and generate static electricity with each other; and
at least one auxiliary filter member attached to at least one of the first and second main filter members, and coated with a material for providing at least one of a sterilization function, an anti-bacterial function, a deodorization function, and an anti-allergic function.

2. The filter according to claim 1, wherein the first and second main filter members and the auxiliary filter member are formed of a polymer plastic.

3. The filter according to claim 1, wherein the first main filter member has a plate shape, and
the second main filter member has a wave shape.

4. The filter according to claim 1, further comprising modules that are vertically stacked,
wherein each of the modules includes the first main filter member, the second main filter member, and the auxiliary filter member,
wherein the second main filter member is placed on a top surface of the first main filter member, and the auxiliary filter member is attached to a surface of at least one of the first and second main filter members.

5. The filter according to claim 1, further comprising modules that are vertically stacked,
wherein each of the modules includes the first main filter member and the second main filter member,
wherein the second main filter member is placed on a top surface of the first main filter member, and the auxiliary filter member is attached to a surface of at least one of the first and second main filter members.

6. A filter comprising:
a first main filter member and a second main filter member, which are at least partially spaced apart from each other to form a channel through which air flows, and which generate static electricity with each other,
wherein at least one of the first and second main filter members includes:
a first member generating static electricity with the other of the first and second main filter members; and
at least one second member attached to the first member, and coated with a material for providing at least one of a sterilization function, an anti-bacterial function, a deodorization function, and an anti-allergic function.

7. The filter according to claim 6, wherein the first and second members comprise a nonwoven fabric formed of polypropylene.

8. The filter according to claim 6, further comprising modules that are vertically stacked,
wherein each of the modules includes the first main filter member and the second main filter member, and the second main filter member is placed on a top surface of the first main filter member,
wherein the first main filter member includes:
the first member; and
the second member attached to a surface of the first member.

9. The filter according to claim 6, further comprising modules that are vertically stacked,
wherein each of the modules includes the first main filter member and the second main filter member, and the second main filter member is placed on a top surface of the first main filter member,
wherein the second main filter member includes:
the first member; and
the second member attached to a surface of the first member.

10. The filter according to claim 6, wherein the first main filter member has a plate shape, and
the second main filter member has a wave shape.

11. A home appliance comprising:
a casing;
an intake port introducing air into the casing;
a discharge port discharging air out of the casing;
a blowing fan providing driving force for causing air flow in and out of the casing through the intake port and the discharge port; and
a filter removing an impurity from air flowing in and out of the casing through the intake port and the discharge port,
wherein the filter includes:
a first main filter member and a second main filter member, which are at least partially spaced apart from each other, and generate static electricity with each other; and
at least one auxiliary filter member attached to at least one of the first and second main filter members, and coated with a material for providing at least one of a sterilization function, an anti-bacterial function, a deodorization function, and an anti-allergic function.

12. The home appliance according to claim 11, wherein the first and second main filter members and the auxiliary filter member are formed of a polymer plastic.

13. The home appliance according to claim 11, wherein the filter includes a channel through which air flows,
one of the first and second main filter member has a plate shape, and the other thereof has a wave shape, to thereby define the channel.

14. The home appliance according to claim 11, wherein the filter comprises modules that are vertically stacked,
wherein each of the modules includes the first main filter member, the second main filter member, and the auxiliary filter member,
wherein the second main filter member is placed on a top surface of the first main filter member, and the auxiliary filter member is attached to a surface of at least one of the first and second main filter members.

15. The home appliance according to claim 11, wherein the filter comprises modules that are vertically stacked,
wherein each of the modules includes the first main filter member and the second main filter member,
wherein the second main filter member is placed on a top surface of the first main filter member, and the auxiliary filter member is attached to a surface of at least one of the first and second main filter members.
